(19) United States
(12) Patent Application Publication
(10) Pub. No.: US 2026/0281884 A1
(43) Pub. Date: Sep. 17, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventors: YASUHARU SEKI, TOKYO (JP); TATSUYA ISHIKAWA, TOKYO (JP); HIROSHI KAGAWA, TOKYO (JP)

(21) Appl. No.: 18/878,698

(22) PCT Filed: Jun. 20, 2023
(86) PCT No.: PCT/JP2023/022700

§ 371 Date: Dec. 24, 2024

(30) Foreign Application Priority Data
Jul. 6, 2022 (JP) 2022-109048

(51) Int. Cl. H04W 48/18; H04W 4/44

(52) U.S. Cl. CPC H04W 48/18; H04W 4/44

(57) ABSTRACT

The present technology relates to an information processing device, an information processing method, and a program that make it possible to stably execute remote support for a mobile object. The information processing device includes a communication unit capable of communication, in a mobile object, with a remote support device which performs remote support for the mobile object via a plurality of communication lines, and a communication control section that selects, on the basis of a characteristic of transmission data including information which is used in the remote support device and a characteristic of each communication line, a communication line for transmitting the transmission data to the remote support device. The present technology can be applied to a system which performs remote driving of a vehicle, for example.

### TECHNICAL FIELD

The present technology relates to an information processing device, an information processing method, and a program, and particularly to an information processing device, an information processing method, and a program suitable for use in the case of performing remote support of a mobile object.

### BACKGROUND ART

In a remote driving system for remotely driving a vehicle, a remote driving device for remotely driving the vehicle acquires information to be used for monitoring a state of the vehicle and a state of surroundings of the vehicle (hereinafter referred to as monitor information) from the vehicle by using wireless communication, for example. Then, an operator operates the remote driving device while viewing the monitor information to remotely drive the vehicle (for example, see PTL 1).

### CITATION LIST

### Patent Literature

### PTL 1

JP 2021-64206A

### SUMMARY

### Technical Problem

However, a quality of communication between the remote driving device and the vehicle is not always stable. For example, an intensity of a communication radio wave fluctuates frequently as the vehicle moves, and communication is instantaneously interrupted due to a handover of a communication station, or the like. Therefore, the remote driving device may fail to acquire monitor information, which may make it difficult to stably execute remote driving.

The present technology has been made in consideration of such circumstances, and enables stable execution of remote support for remote driving and the like of a mobile object such as a vehicle.

### Solution to Problem

An information processing device of one aspect of the present technology includes a communication unit capable of communicating, in a mobile object, with a remote support device that performs remote support for the mobile object via a plurality of communication lines; and a communication control section that selects a communication line that transmits transmission data to the remote support device, on the basis of a characteristic of the transmission data including information to be used in the remote support device and a characteristic of each of the communication lines.

In an information processing method of one aspect of the present technology, an information processing device capable of communicating, in a mobile object, with a remote support device that performs remote support for the mobile object via a plurality of communication lines, selects a communication line for transmitting transmission data to the remote support device, on the basis of a characteristic of the transmission data including information to be used in the remote support device and a characteristic of each of the communication lines.

A program of one aspect of the present technology causes a computer capable of communicating, in a mobile object, with a remote support device that performs remote support for the mobile object via a plurality of communication lines to select a communication line for transmitting transmission data to the remote support device, on the basis of a characteristic of the transmission data including information to be used in the remote support device and a characteristic of each of the communication lines.

In one aspect of the present technology, the communication line for transmitting the transmission data to the remote support device is selected on the basis of the characteristic of the transmission data including information to be used in the remote support device and the characteristic of each of the communication lines.

### BRIEF DESCRIPTION OF DRAWINGS

FIG. 1 is a schematic diagram of an example of a configuration of a remote support system to which the present technology is applied.

FIG. 2 is a block diagram illustrating an example of a configuration of a remote driving system to which the present technology is applied.

FIG. 3 is a flowchart for illustrating processing of a vehicle in the remote driving system.

FIG. 4 is a flowchart for illustrating processing of a remote driving device of the remote driving system.

FIG. 5 is a block diagram illustrating an example of a computer configuration.

### DESCRIPTION OF EMBODIMENTS

The following describes embodiments for applying the present technology. The description will be given in the following order.
1. Embodiment
2. Modifications
3. Others

### 1. Embodiment

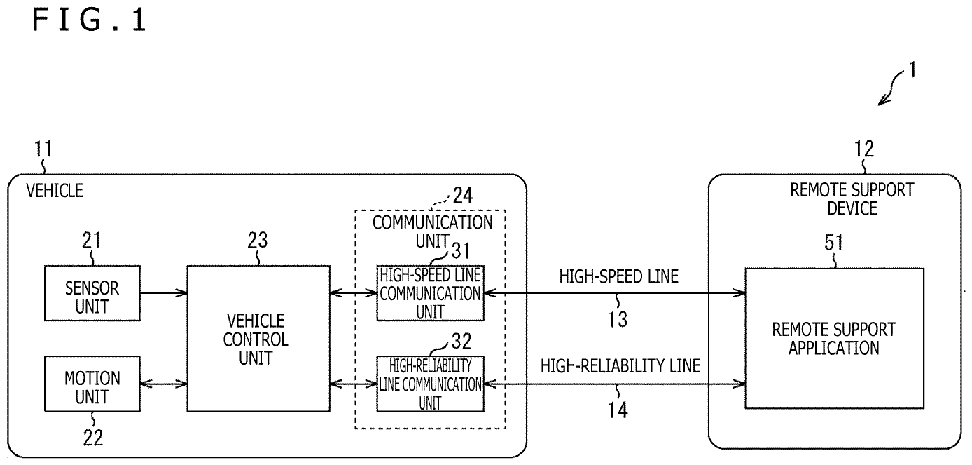

FIG. 1 illustrates an overview of a configuration example of a remote support system 1 to which the present technology can be applied.

The remote support system 1 is a system that performs remote support for a vehicle 11 by using a remote support device 12.

Here, remote support means, for example, support to the vehicle 11 from a remote location via communication in an environment in which the vehicle 11 and the surroundings of the vehicle 11 can be monitored. For example, remote support is provided in an environment in which a communication situation, a driving environment, a state of the vehicle 11, a state of a LSADS (Low-Speed Automated Driving System), passengers, a cargo, etc. can be monitored. The entity providing the remote support is usually a human being, but may be a system using AI (Artificial Intelligence) or the like.

The remote support includes remote monitoring, remote assistance, and remote driving, for example.

The remote monitoring means monitoring the vehicle 11 and the surroundings of the vehicle 11 from a remote location via communication, for example.

The remote assistance refers to providing information to the vehicle 11 from a remote location via communication in an event-driven manner such that the vehicle 11 can continue moving when the vehicle 11 encounters a situation that the ADS (Auto Driving System) of the vehicle 11 cannot handle, for example.

The remote driving refers to executing, from a remote location, some or all of the DDTs (Dynamic Driving Tasks) and/or DDT fallbacks of the vehicle 11 in real time, for example. The DDTs include braking, steering, acceleration, and transmission shifting, for example.

The vehicle 11 and the remote support device 12 can communicate with each other via a plurality of communication lines having different characteristics. For example, the vehicle 11 and the remote support device 12 communicate with each other via two communication lines, namely a high-speed line 13 and a high-reliability line 14 having different characteristics.

The high-speed line 13 is a communication line in which a communication speed is fast and has a low latency, but has unstable communication quality and low reliability, compared to the high-reliability line 14. For example, the high-speed line 13 is a communication line that has characteristics such as a small size of a cell that is a range that radio waves can reach, or large quality fluctuations associated with moving. Specifically, communication lines for 5G (fifth generation mobile communication system), millimeter wave communication, etc. are assumed, for example.

The high-reliability line 14 is a communication line in which the communication speed is slow and has a high latency, but has stable communication quality and high reliability, compared to the high-speed line 13. For example, the high-reliability line 14 is a communication line in which the communication has slow to medium speed, but has a large cell size, and can ensure a stable connection. Specifically, communication lines of LTE (Long Term Evolution), LPWA (LOW Power Wide Area), etc. are assumed, for example.

The vehicle 11 includes a sensor unit 21, a motion unit 22, a vehicle control unit 23, and a communication unit 24. The communication unit 24 includes a high-speed line communication unit 31 and a high-reliability line communication unit 32.

The sensor unit 21 includes sensors that acquire information regarding the vehicle 11 and information regarding the surroundings of the vehicle 11. For example, the sensor unit 21 includes a camera, LiDAR (Light Detection And Ranging), radar, etc. The sensor unit 21 supplies sensor data output from each sensor to the vehicle control unit 23.

The motion unit 22 includes a system for enabling various motions such as traveling of the vehicle 11. For example, the motion unit 22 executes steering, driving, braking, etc. of the vehicle 11 under the control of the vehicle control unit 23. In addition, the motion unit 22 supplies information indicating the state of the vehicle 11 (hereinafter referred to as vehicle state information) to the vehicle control unit 23.

The vehicle control unit 23 includes, for example, an ECU (Electronic Control Unit) or the like, and constitutes an AD/ADAS (Automated Driving/Advanced Driver Assist System) or the like.

For example, the vehicle control unit 23 detects the state of the vehicle 11 and the state around the vehicle 11 on the basis of sensor data and vehicle state information.

The vehicle control unit 23 generates information to be used for executing remote support in the remote support device 12 (hereinafter referred to as information for the remote support device), on the basis of the sensor data, the vehicle state information, and detection results of the state of the vehicle 11 and the state around the vehicle 11. The information for the remote support device includes, for example, monitor information used for monitoring the state of the vehicle 11 and the state around the vehicle 11. The monitor information includes, for example, sensor information including sensor data or data similar to the sensor data. Note that data similar to the sensor data is data that has been subjected to processing (for example, compression processing, thinning processing, conversion processing, etc.) for reducing the amount of data of the sensor data, for example.

The vehicle control unit 23 monitors the communication situations of the high-speed line 13 and the high-reliability line 14 on the basis of information from the communication unit 24.

The vehicle control unit 23 controls the transmission, to the remote support device 12, of the transmission data including at least part of the information for the remote support device. For example, the vehicle control unit 23 controls an amount of the transmission data and selects a communication line for transmitting the transmission data, on the basis of the characteristics of the transmission data and the characteristics of each communication line.

Note that the characteristics of the transmission data include at least one of the amount, a type, and an importance of the transmission data, for example. The characteristics of the communication line include at least one of the communication speed, the reliability, and the communication situations, for example.

For example, the transmission data transmitted via the high-speed line 13 (hereinafter referred to as high-speed line transmission data) is regarded as transmission data with a large amount of data or transmission data with a low importance, compared to the transmission data transmitted via the high-reliability line 14 (hereinafter referred to as high-reliability line transmission data). For example, the high-speed line transmission data includes more detailed information, compared to the high-speed line reliability data. Specifically, for example, the high-speed line transmission data includes sensor information.

In contrast, the high-reliability line transmission data is regarded as transmission data with a small amount of data or transmission data with a high importance, compared to the high-speed line transmission data. For example, the high-reliability line transmission data includes simplified or abstracted information, compared to the high-speed line reliability data. Specifically, for example, the high-reliability line transmission data includes the information minimally required to execute the remote support. For example, the high-reliability line transmission data includes a sensor processing result that is a result of executing a predetermined process (for example, object recognition process, etc.) on the basis of the sensor data. For example, the sensor processing result includes information detected on the basis of the sensor data. To be specific, for example, the sensor processing result includes a recognition result of objects around the vehicle 11, traveling information such as a position and a speed of the vehicle 11, traffic lane information, proximity detection warning information, etc.

The vehicle control unit 23 controls the motion of the vehicle 11 by controlling the motion unit 22 on the basis of sensor data, vehicle state information, detection results of the state of the vehicle 11 and the state around the vehicle 11 or the like, as well as remote support information transmitted from the remote support device 12.

The remote support information includes information for executing remote support for the vehicle 11. Specifically, for example, the remote support information includes various commands for the vehicle 11, and the like.

The high-speed line communication unit 31 includes a TCU (Telematics Control Unit) etc., for example. The high-speed line communication unit 31 communicates with the remote support device 12 via the high-speed line 13 and transmits high-speed line transmission data to the remote support device 12.

The high-reliability line communication unit 32 includes a TCU etc., for example. The high-reliability line communication unit 32 communicates with the remote support device 12 via the high-reliability line 14 and transmits high-reliability line transmission data to the remote support device 12. For example, the high-reliability line communication unit 32 receives remote support information from the remote support device 12 via the high-reliability line 14.

The remote support device 12 includes a dedicated device, a PC (Personal Computer), a smartphone, etc., for example. Incidentally, the remote support device 12 may include a plurality of devices.

The remote support device 12 performs remote support by executing a remote support application 51. For example, the remote support device 12 receives high-speed line transmission data from the vehicle 11 via the high-speed line 13, and receives high-reliability line transmission data from the vehicle 11 via the high-reliability line 14.

For example, the remote support device 12 presents, to the operator, monitor information for monitoring the state of the vehicle 11 and the state around the vehicle 11 on the basis of high-speed line transmission data and high-reliability line transmission data.

In response to this, the operator operates the remote support device 12 to provide remote support for the vehicle 11 according to the state of the vehicle 11 and the state of the surroundings of the vehicle 11 recognized on the basis of the monitor information.

In response to this, the remote support device 12 generates remote support information on the basis of operations by the operator, and transmits the information to the vehicle 11 via the high-reliability line 14.

### Configuration Example of the Remote Driving System 101

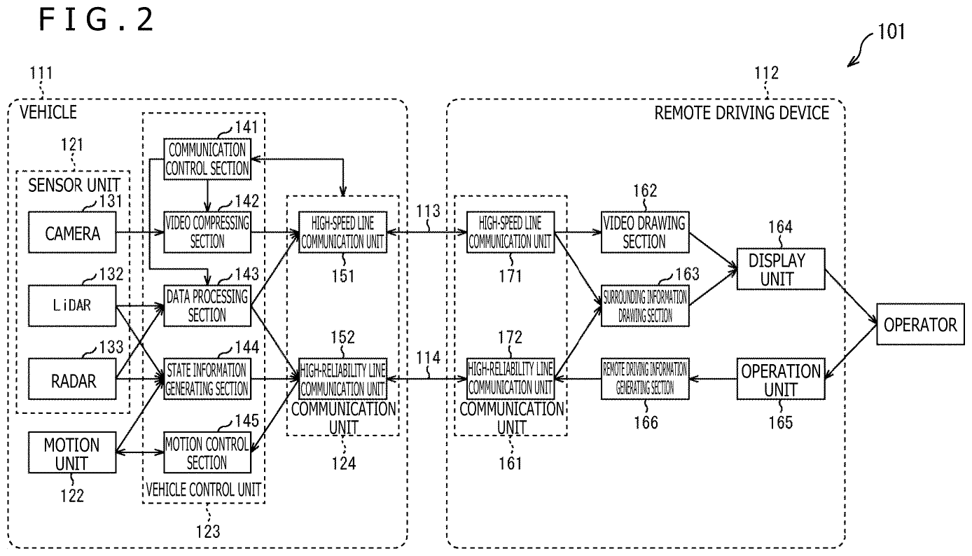

FIG. 2 illustrates a configuration example of a remote driving system 101, which is one embodiment of the remote support system 1 in FIG. 1. The remote driving system 101 is a system that remotely drives a vehicle 111 by using a remote driving device 112.

The vehicle 111 and the remote driving device 112 communicate with each other via a high-speed line 113 and a high-reliability line 114, which have different characteristics. The high-speed line 113 is a communication line similar to the high-speed line 13 in FIG. 1. The high-reliability line 114 is a communication line similar to the high-reliability line 14 in FIG. 1.

The vehicle 111 includes a sensor unit 121, a motion unit 122, a vehicle control unit 123, and a communication unit 124. The sensor unit 121, the motion unit 122, the vehicle control unit 123, and the communication unit 124 correspond to the sensor unit 21, the motion unit 22, the vehicle control unit 23, and the communication unit 24 of the vehicle 11 in FIG. 1, respectively.

The sensor unit 121 includes a camera 131, a LiDAR 132, and a radar 133.

The camera 131 captures images of the surroundings of the vehicle 111 and supplies the obtained video data to a video compressing section 142 in the vehicle control unit 123.

The LiDAR 132 senses the surroundings of the vehicle 111 and generates point cloud data on the basis of the sensing result. The LiDAR 132 supplies the generated point cloud data to a data processing section 143 and a state information generating section 144 of the vehicle control unit 123.

The radar 133 senses the surroundings of the vehicle 111 and generates radar image data on the basis of the sensing results. The radar 133 supplies the generated radar image data to the data processing section 143 and the state information generating section 144 of the vehicle control unit 123.

The motion unit 122 includes a system for allowing various motions such as traveling of the vehicle 111. For example, the motion unit 122 executes steering, driving, braking, and the like of the vehicle 111 under the control of the vehicle control unit 123. In addition, the motion unit 122 supplies vehicle state information indicating the state of the vehicle 111 to the state information generating section 144 and a motion control section 145 of the vehicle control unit 123.

The vehicle control unit 123 includes an ECU etc., and configures an AD/ADAS etc., for example. The vehicle control unit 123 includes a communication control section 141, the video compressing section 142, the data processing section 143, the state information generating section 144, and the motion control section 145.

The communication control section 141 monitors the communication situations of the high-speed line 113 and the high-reliability line 114 on the basis of information from the communication unit 124.

The communication control section 141 controls the video compressing section 142 on the basis of the communication situations of the high-speed line 113 and the high-reliability line 114. For example, the communication control section 141 controls the compression rate of the video data of the video compressing section 142.

The communication control section 141 controls the data processing section 143 on the basis of the communication situations of the high-speed line 113 and the high-reliability line 114. For example, the communication control section 141 controls predetermined data processing (e.g., thinning processing or the like) performed by the data processing section 143 on the point cloud data and radar image data. For example, the communication control section 141 selects a supply destination of the point cloud data and radar image data from the data processing section 143 from among a high-speed line communication unit 151 and a high-reliability line communication unit 152 of the communication unit 124. As a result, the communication control section 141 selects the communication line for transmitting the point cloud data and the radar image data.

The video compressing section 142 compresses the video data and supplies the compressed video data to the high-speed line communication unit 151.

The data processing section 143 reduces the amount of data of the point cloud data and radar image data by performing predetermined data processing (e.g., thinning processing, etc.) on the point cloud data and radar image data as necessary under the control of the communication control section 141. Under the control of the communication control section 141, the data processing section 143 supplies the point cloud data and radar image data to the high-speed line communication unit 151 or the high-reliability line communication unit 152 of the communication unit 124.

The state information generating section 144 detects the state of the vehicle 111 and the state of the surroundings of the vehicle 111 on the basis of the point cloud data, the radar image data, and the vehicle state information, and generates state information indicating the detection result. The state information includes vehicle state information indicating the state of the vehicle 111, and surrounding state information indicating the state of the surroundings of the vehicle 111. The surrounding state information includes at least one of, for example, a recognition result of objects around the vehicle 111, traveling information such as the position and the speed of the vehicle 111, the traffic lane information, the proximity detection warning information, etc. The state information generating section 144 supplies the state information to the high-reliability line communication unit 152.

The motion control section 145 controls the motion of the vehicle 111 by controlling the motion unit 122 on the basis of the motion state information and the remote driving information transmitted from the remote driving device 112.

The remote driving information includes information for executing remote driving for the vehicle 111. Specifically, for example, the remote driving information includes various commands for the vehicle 111, or the like.

The communication unit 124 includes the high-speed line communication unit 151 and the high-reliability line communication unit 152. The high-speed line communication unit 151 and the high-reliability line communication unit 152 correspond to the high-speed line communication unit 31 and the high-reliability line communication unit 32 of the vehicle 11 in FIG. 1, respectively.

The high-speed line communication unit 151 communicates with the remote driving device 112 via the high-speed line 113. For example, the high-speed line communication unit 151 transmits video data, point cloud data, and radar image data to the remote driving device 112 via the high-speed line 113.

The high-reliability line communication unit 152 communicates with the remote driving device 112 via the high-reliability line 114. For example, the high-reliability line communication unit 152 transmits point cloud data, radar image data, and state information to the remote driving device 112 via the high-reliability line 114. For example, the high-reliability line communication unit 152 receives remote driving information from the remote driving device 112 via the high-reliability line 114. The high-reliability line communication unit 152 supplies the remote driving information to the motion control section 145.

The remote driving device 112 includes a dedicated device, a PC, a smartphone, or the like, for example. Incidentally, the remote driving device 112 may include a plurality of devices.

The remote driving device 112 includes a communication unit 161, a video drawing section 162, a surrounding information drawing section 163, a display unit 164, an operation unit 165, and a remote driving information generating section 166.

The communication unit 161 includes a high-speed line communication unit 171 and a high-reliability line communication unit 172.

The high-speed line communication unit 171 communicates with the vehicle 111 via the high-speed line 113. For example, the high-speed line communication unit 171 receives video data, point cloud data, and radar image data from the vehicle 111 via the high-speed line 113. The high-speed line communication unit 171 supplies the video data to the video drawing section 162, and supplies the point cloud data and radar image data to the surrounding information drawing section 163.

The high-reliability line communication unit 172 communicates with the vehicle 111 via the high-reliability line 114. For example, the high-reliability line communication unit 172 receives point cloud data, radar image data, and state information from the vehicle 111 via the high-reliability line 114. The high-speed line communication unit 171 supplies the point cloud data, the radar image data, and the state information to the surrounding information drawing section 163.

The video drawing section 162 generates videos for drawing use (hereinafter referred to as videos for drawing) on the basis of the video data, and supplies the videos to the display unit 164. However, in the case where the quality of the video data is deteriorated, the video drawing section 162 stops generating and supplying the videos for drawing.

The surrounding information drawing section 163 generates information for drawing (hereinafter referred to as surrounding information for drawing) indicating the state of the surroundings of the vehicle 111 on the basis of the point cloud data, the radar image data, and the surrounding state information contained in the state information, and supplies the information to the display unit 164.

The display unit 164 includes a display device and the like, and displays information used by the operator to execute remote driving. For example, in the case where a video for drawing is supplied from the video drawing section 162, the display unit 164 displays the surrounding information for drawing by superimposing the information on the video for drawing. In the case where a video for drawing is not supplied from the video drawing section 162, the display unit 164 displays only the surrounding information for drawing.

The operation unit 165 includes an operation device that is used by an operator to execute remote driving of the vehicle 111. The operation unit 165 supplies the remote driving information generating section 166 with an operation signal corresponding to an operation by the operator.

The remote driving information generating section 166 generates remote driving information on the basis of the operation signal and supplies the information to the high-reliability line communication unit 172.

### Processing of the Remote Driving System

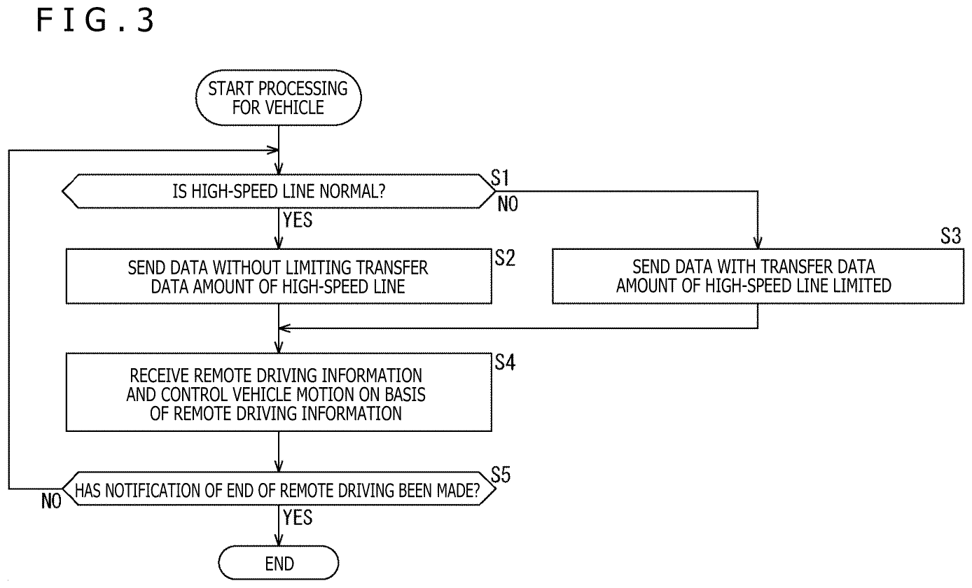

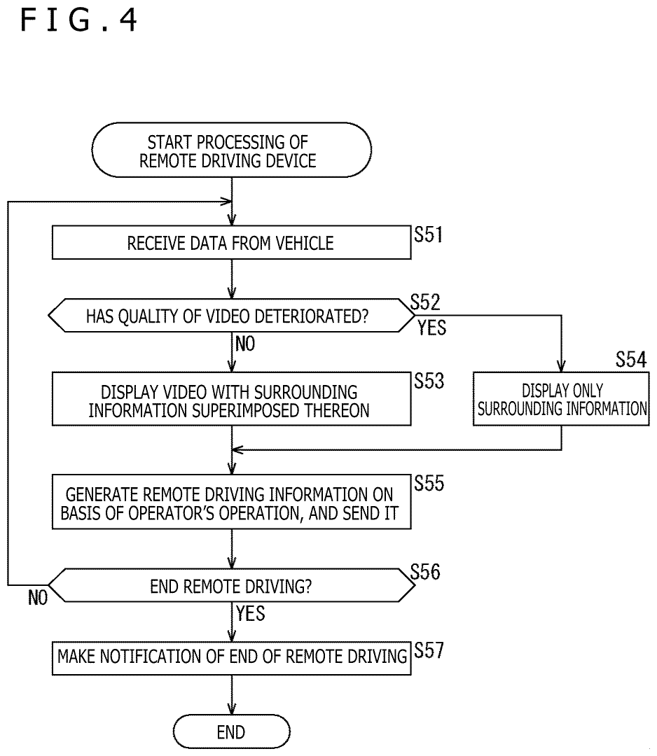

Next, the processing of the remote driving system 101 will be described with reference to FIGS. 3 and 4.

### Processing of the Vehicle 111

First, the processing of the vehicle 111 will be described with reference to the flowchart in FIG. 3.

This processing starts, for example, when the power of the vehicle 111 is turned on.

In step S1, the communication control section 141 determines whether or not the high-speed line 113 is normal. To be specific, the communication control section 141 acquires information regarding the current communication situation of the high-speed line 113 from the high-speed line communication unit 151. The communication control section 141 determines whether or not the high-speed line 113 is normal on the basis of the acquired information.

It should be noted that the conditions for determining whether the high-speed line 113 is normal or not are not particularly limited. For example, the communication control section 141 determines whether the high-speed line 113 is normal or not on the basis of at least one of a communication speed, a bandwidth, and an error rate of the high-speed line 113. To be specific, the communication control section 141 compares at least one of the communication speed, the bandwidth, and the error rate of the high-speed line 113 with a predetermined threshold, for example. In the case where all of them are equal to or greater than the threshold, the communication control section 141 determines that the high-speed line 113 is normal, and in the case where any one of them is less than the threshold, the communication control section 141 determines that the high-speed line 113 is abnormal. In the case of determination that the high-speed line 113 is normal, the process proceeds to step S2.

In step S2, the vehicle 111 transmits data without limiting the amount of data transferred through the high-speed line 113.

To be specific, the camera 131 captures images of the surroundings of the vehicle 111 and supplies the obtained video data to the video compressing section 142. The video compressing section 142 compresses the video data and supplies the compressed video data to the high-speed line communication unit 151. The high-speed line communication unit 151 transmits the video data to the remote driving device 112 via the high-speed line 113.

The LiDAR 132 senses the surroundings of the vehicle 111 and generates point cloud data on the basis of the sensing results. The LiDAR 132 supplies the generated point cloud data to the data processing section 143 and the state information generating section 144. Under the control of the communication control section 141, the data processing section 143 supplies the point cloud data as it is to the high-speed line communication unit 151. The high-speed line communication unit 151 transmits the point cloud data to the remote driving device 112 via the high-speed line 113.

The radar 133 senses the surroundings of the vehicle 111 and generates radar image data on the basis of the sensing results. The radar 133 supplies the generated radar image data to the data processing section 143 and the state information generating section 144. Under the control of the communication control section 141, the data processing section 143 supplies the radar image data as it is to the high-speed line communication unit 151. The high-speed line communication unit 151 transmits the radar image data to the remote driving device 112 via the high-speed line 113.

The state information generating section 144 acquires vehicle state information from the motion unit 122. The state information generating section 144 detects the state of the vehicle 111 and the state of the surroundings of the vehicle 111 on the basis of the point cloud data, the radar image data, and the vehicle state information, and generates state information indicating the detection result. The state information generating section 144 supplies the state information to the high-reliability line communication unit 152. The high-reliability line communication unit 152 transmits the state information to the remote driving device 112 via the high-reliability line 114.

After that, the process proceeds to step S4.

Meanwhile, in the case of determination that the high-speed line 113 is abnormal in step S1, the process proceeds to step S3.

In step S3, the vehicle 111 limits the amount of data transferred through the high-speed line 113 and transmits the data.

To be specific, the camera 131 captures images of the surroundings of the vehicle 111 and supplies the obtained video data to the video compressing section 142. The video compressing section 142 compresses the video data and supplies the compressed video data to the high-speed line communication unit 151. At this time, under the control of the communication control section 141, the video compressing section 142 may increase the compression rate, compared to the case where the high-speed line 113 is normal. This reduces the quality of the video data, but reduces the amount of data.

The high-speed line communication unit 151 transmits the video data to the remote driving device 112 via the high-speed line 113. Note that, in this case, the possibility of failure in transmitting the video data increases.

The LiDAR 132 senses the surroundings of the vehicle 111 and generates a point cloud data on the basis of the sensing results. The LiDAR 132 supplies the generated point cloud data to the data processing section 143 and the state information generating section 144. The data processing section 143 performs predetermined data processing (e.g., thinning processing, etc.) on the point cloud data under the control of the communication control section 141 to reduce the amount of data. This reduces the quality of the point cloud data, but increases the possibility that the transmission of the point cloud data via the high-reliability line 114 will be successful. The data processing section 143 supplies the point cloud data with the amount of data reduced to the high-reliability line communication unit 152. The high-reliability line communication unit 152 transmits the point cloud data to the remote driving device 112 via the high-reliability line 114.

The radar 133 senses the surroundings of the vehicle 111 and generates radar image data on the basis of the sensing results. The radar 133 supplies the generated radar image data to the data processing section 143 and the state information generating section 144. The data processing section 143 performs predetermined data processing (e.g., thinning processing, etc.) on the radar image data under the control of the communication control section 141 to reduce the amount of data. This reduces the quality of the radar image data, but increases the possibility that the radar image data will be successfully transmitted via the high-reliability line 114. The data processing section 143 supplies the radar image data with the amount of data reduced to the high-reliability line communication unit 152. The high-reliability line communication unit 152 transmits the radar image data to the remote driving device 112 via the high-reliability line 114.

The state information generating section 144 acquires vehicle state information from the motion unit 122. The state information generating section 144 detects the state of the vehicle 111 and the state of the surroundings of the vehicle 111 on the basis of the point cloud data, the radar image data, and the vehicle state information, and generates state information indicating the detection result. The state information generating section 144 supplies the state information to the high-reliability line communication unit 152. The high-reliability line communication unit 152 transmits the state information to the remote driving device 112 via the high-reliability line 114.

After that, the process proceeds to step S4.

In step S4, the vehicle 111 receives the remote driving information and controls the motion of the vehicle 111 on the basis of the remote driving information. To be specific, the high-reliability line communication unit 152 receives the remote driving information transmitted from the remote driving device 112 via the high-reliability line 114, and supplies the information to the motion control section 145. The motion control section 145 controls the motion of the vehicle 111 by controlling the motion unit 122 on the basis of the remote driving information. For example, the steering, driving, braking, etc. of the vehicle 111 are controlled.

In step S5, the motion control section 145 determines whether or not the notification of end of the remote driving has been made, on the basis of the remote driving information. In the case of determination that the notification of end of the remote driving has not been made, the process returns to step S1.

Thereafter, the processes of steps S1 to S5 are repeatedly executed until it is determined in step S5 that the notification of end of the remote driving has been made.

Meanwhile, in the case of determination in step S5 that the notification of end of the remote driving has been made, the processing of the vehicle 111 ends.

### Processing of the Remote Driving Device 112

Next, referring to the flowchart in FIG. 4, the processing of the remote driving device 112 corresponding to the processing of the vehicle 111 in FIG. 3 will be described.

In step S51, the remote driving device 112 receives data from the vehicle 111.

To be specific, in the case where the vehicle 111 does not limit the amount of data transferred through the high-speed line 113, the high-speed line communication unit 171 receives video data, point cloud data, and radar image data from the vehicle 111 via the high-speed line 113. The high-speed line communication unit 171 supplies the video data to the video drawing section 162, and supplies the point cloud data and the radar image data to the surrounding information drawing section 163. The high-reliability line communication unit 172 receives state information from the vehicle 111 via the high-reliability line 114. The high-reliability line communication unit 172 supplies the state information to the surrounding information drawing section 163.

In contrast, in the case where the vehicle 111 limits the amount of data transferred on the high-speed line 113, the high-speed line communication unit 171 receives video data from the vehicle 111 via the high-speed line 113. The high-speed line communication unit 171 supplies the video data to the video drawing section 162. Incidentally, in this case, there is a high possibility that reception of the video data will fail. The high-reliability line communication unit 172 receives the point cloud data, radar image data, and state information from the vehicle 111 via the high-reliability line 114. The high-reliability line communication unit 172 supplies the point cloud data, the radar image data, the and state information to the surrounding information drawing section 163.

In step S52, the video drawing section 162 determines whether or not the quality of the video has deteriorated, on the basis of the received video data. In the case of determination that the quality of the video has not deteriorated, the process proceeds to step S53.

In step S53, the remote driving device 112 displays the video with the surrounding information superimposed thereon. Specifically, the video drawing section 162 generates a video for drawing on the basis of the video data, and supplies the video to the display unit 164.

The surrounding information drawing section 163 generates surrounding information for drawing on the basis of the point cloud data, the radar image data, and the surrounding state information included in the state information, and supplies the generated surrounding information to the display unit 164. For example, the surrounding information for drawing includes, for example, the recognition result of objects around the vehicle 111, traveling information such as the position and the speed of the vehicle 11, the traffic lane information, the proximity detection warning information, etc. Furthermore, for example, the surrounding information for drawing may include the point cloud data and the radar image data itself.

The display unit 164 displays the surrounding information for drawing by superimposing the information on the video for drawing.

This allows the operator to monitor the states around the vehicle 111 in detail, on the basis of the video and the surrounding information.

Then, the process proceeds to step S55.

On the other hand, in the case of determination in step S52 that the quality of the video has deteriorated, the process proceeds to step S54.

In step S54, the remote driving device 112 displays only the surrounding information. Specifically, the video drawing section 162 stops generating and supplying the video for drawing. The surrounding information drawing section 163 generates surrounding information for drawing, on the basis of the point cloud data, the radar image data, and the surrounding state information included in the state information, and supplies the generated surrounding information to the display unit 164. The display unit 164 displays only the surrounding information for drawing.

In this way, even if an abnormality occurs in the high-speed line 13 and the display of the video for drawing is stopped, the surrounding information for drawing continues to be displayed. This allows the operator to understand and estimate the state around the vehicle 111 on the basis of the surrounding information for drawing. As a result, remote driving of the vehicle 111 continues stably regardless of an abnormality in the high-speed line 13. Furthermore, for example, in the case where the operator determines that remote driving cannot be continued safely because the video is not displayed, the operator can safely stop the vehicle 111 while seeing the surrounding information for drawing. This avoids danger to the vehicle 111.

Furthermore, even if an abnormality occurs in the high-speed line 13, the amount of data will be reduced, but the point cloud data and radar image data will continue to be transmitted, so that a decrease in the amount of surrounding information for drawing is suppressed.

Then, the process proceeds to step S55.

In step S55, the remote driving device 112 generates remote driving information on the basis of the operation of the operator, and transmits the information.

To be specific, the operator performs operations to move the vehicle 111 appropriately while viewing the information displayed on the display unit 164.

In response to this, the operation unit 165 generates an operation signal corresponding to the operation of the operator and supplies the signal to the remote driving information generating section 166. The remote driving information generating section 166 generates remote driving information for giving instructions for steering, driving, braking, etc. to the vehicle 111, on the basis of the operation signal, and supplies the information to the high-reliability line communication unit 172. The high-reliability line communication unit 172 transmits the remote driving information to the vehicle 111 via the high-reliability line 114.

Here, the remote driving information is reliably transmitted to the vehicle 111 via the high-reliability line 114 having high reliability, which improves the reliability of the remote driving of the vehicle 111.

In step S56, the remote driving information generating section 166 determines whether or not to end the remote driving, on the basis of the operation signal from the operation unit 165. In the case where it is determined not to end the remote driving, the process returns to step S51.

Thereafter, the processes of steps S51 to S56 are repeatedly executed until it is determined in step S56 that the remote driving is to be ended.

On the other hand, in step S56, for example, in the case where the operator performs an operation to finish remote driving on the operation unit 165, the remote driving information generating section 166 determines to finish the remote driving, on the basis of the operation signal from the operation unit 165, and the processing proceeds to step S57.

In step S57, the remote driving device 112 makes a notification of the end of remote driving. To be specific, the remote driving information generating section 166 generates remote driving information for making a notification of the end of remote driving, and supplies the remote driving information to the high-reliability line communication unit 172. The high-reliability line communication unit 172 transmits the remote driving information to the vehicle 111 via the high-reliability line 114.

After that, the processing of the remote driving device 112 ends.

In this way, even if an abnormality occurs in the high-speed line 113, the information minimally required for remote driving can be continuously transmitted from the vehicle 111 to the remote driving device 112. This makes it possible to stably execute remote driving.

### 2. Modifications

Modifications of the above-mentioned embodiment of the present technology will be described, below.

For example, the state information generating section 144 of the vehicle 111 in FIG. 2 may generate state information by using video data acquired from the camera 131.

For example, the vehicle 111 may stop transmitting video data in the case where an abnormality occurs in the high-speed line 113. Furthermore, for example, the vehicle 111 may stop transmitting point cloud data and radar image data in the case where an abnormality occurs in the high-speed line 113.

For example, in the case where the transmission data is large in volume but contains highly important information, the data may be transmitted via a high-reliability line even if no abnormality has occurred on the high-speed line. Conversely, in the case where the transmission data is small in volume but contains only low-importance information, the data may be transmitted via a high-speed line.

For example, in the case where an abnormality occurs in the high-speed line 113, the remote driving device 112 may display the surrounding information for drawing superimposed on the point cloud data or the radar image data.

For example, three or more types of communication lines can be set between the vehicle 11 and the remote support device 12 and between the vehicle 111 and the remote driving device 112.

This technology can be applied, for example, to mobile objects other than vehicles, which are capable of being remotely supported (e.g., drones, etc.).

The present technology can be applied to both manned and unmanned mobile objects as long as the mobile objects are capable of being remotely supported, for example.

### 3. Others

### Examples of Computer Configurations

The series of processes described above can be executed by hardware or software. In the case of executing the series of processes by software, programs that constitute the software are installed on the computer. Here, computers include computers built into dedicated hardware, and general-purpose personal computers, for example, that can execute various functions by installing various programs.

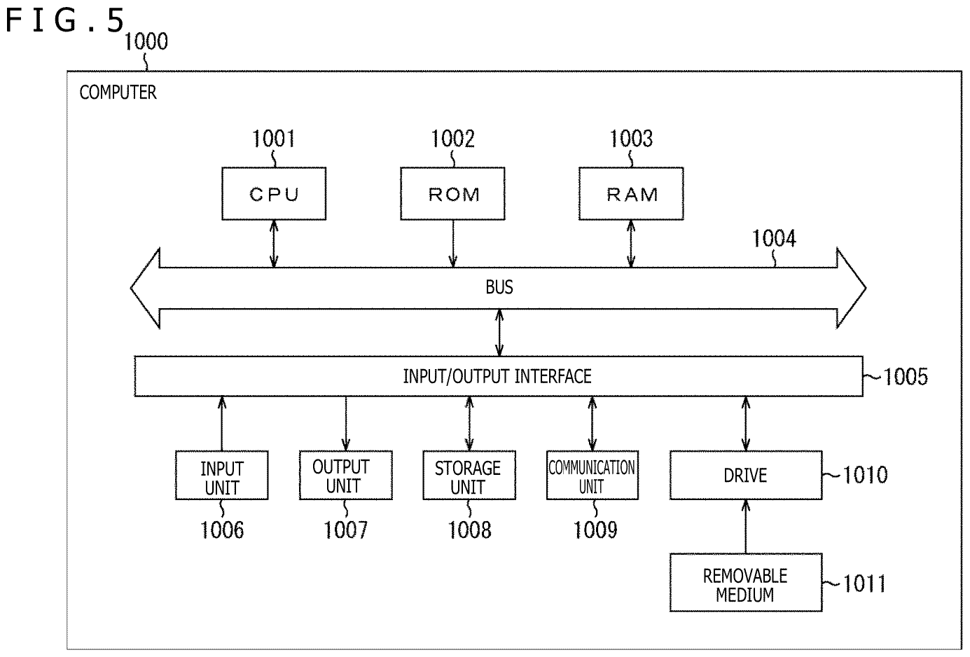

FIG. 5 is a block diagram illustrating an example of a hardware configuration of a computer that executes the series of processes described above by a program.

In a computer 1000, a CPU (Central Processing Unit) 1001, a ROM (Read Only Memory) 1002, and a RAM (Random Access Memory) 1003 are interconnected by a bus 1004.

An input/output interface 1005 is further connected to the bus 1004. To the input/output interface 1005, an input unit 1006, an output unit 1007, a storage unit 1008, a communication unit 1009, and a drive 1010 are connected.

The input unit 1006 includes an input switch, a button, a microphone, an imaging element, and the like. The output unit 1007 includes a display, a speaker, and the like. The storage unit 1008 includes a hard disk, a non-volatile memory, and the like. The communication unit 1009 includes a network interface and the like. The drive 1010 drives a removable medium 1011 such as a magnetic disk, an optical disk, a magneto-optical disk, or a semiconductor memory.

In the computer 1000 configured as described above, the CPU 1001 loads, for example, a program recorded in the storage unit 1008 into the RAM 1003 via the input/output interface 1005 and the bus 1004, and executes the program, thereby performing the series of processes described above.

The program executed by the computer 1000 (CPU 1001) can be provided by being recorded on the removable medium 1011 such as a package medium, for example. In addition, the program can also be provided via a wired or wireless transmission medium such as a local area network, the Internet, or digital satellite broadcasting.

In the computer 1000, the program can be installed in the storage unit 1008 via the input/output interface 1005 by mounting the removable medium 1011 in the drive 1010. Further, the program can also be received by the communication unit 1009 via a wired or wireless transmission medium and installed in the storage unit 1008. Alternatively, the program can be installed in the ROM 1002 or the storage unit 1008 in advance.

Incidentally, the program executed by the computer may be a program in which processing is performed chronologically in the order described in the present description, or may be a program in which processing is performed in parallel or at the required timing, such as when called.

Further, in the present description, a system refers to a collection of a plurality of components (devices, modules (parts), etc.), regardless of whether all the components are in the same housing. Therefore, a plurality of devices housed in separate housings and connected via a network, and a single device in which a plurality of modules is housed in a single housing, are both systems.

Furthermore, the embodiments of the present technology are not limited to the above-described embodiments, and various modifications are possible without departing from the gist of the present technology.

For example, the present technology can be configured as cloud computing, in which a single function is shared and processed collaboratively by a plurality of devices via a network.

Furthermore, each step described in the above flow chart can be executed by one device, or can be shared and executed by a plurality of devices.

Furthermore, in the case where a single step includes a plurality of processes, the plurality of processes included in the single step can be executed by a single device, or can be shared and executed by a plurality of devices.

### Examples of Configuration Combinations

The present technology can also be configured as follows.
(1)

An information processing device including:
a communication unit capable of communicating, in a mobile object, with a remote support device that performs remote support for the mobile object via a plurality of communication lines; and
a communication control section that selects a communication line that transmits transmission data to the remote support device, on the basis of a characteristic of the transmission data including information to be used in the remote support device and a characteristic of each of the communication lines.
(2)

The information processing device according to (1) above, in which
the plurality of communication lines includes a first communication line, and a second communication line which has a slower communication speed and higher reliability than the first communication line.
(3)

The information processing device according to (2) above, in which
the communication control section selects the first communication line for first transmission data, and selects the second communication line for second transmission data, which is data having a smaller data amount than the first transmission data or data having a higher importance than the first transmission data.
(4)

The information processing device according to (3) above, in which
the communication control section selects the second communication line for the first transmission data in a case where an abnormality occurs in the first communication line.
(5)

The information processing device according to (4) above, further including:
a data processing section that reduces a data amount of the first transmission data, in a case where the first transmission data is transmitted via the second communication line.
(6)

The information processing device according to any one of (3) to (5) above, in which
the first transmission data includes sensor data from at least one of one or more sensors that acquire information regarding at least one of the mobile object and surroundings of the mobile object, or sensor information including similar data, and
the second transmission data includes a sensor processing result that is a result of performing a predetermined process on the sensor data from at least one of the sensors.
(7)

The information processing device according to (6) above, in which
the sensor processing result includes information detected on the basis of the sensor data from at least one of the sensors.
(8)

The information processing device according to (7) above, in which
the sensor information includes video data of the surroundings of the mobile object, and
the sensor processing result includes a detection result of a state of the surroundings of the mobile object.
(9)

The information processing device according to (8) above, in which
in the remote support device, information in which the detection result of the state of the surroundings of the mobile object is superimposed on a video based on the video data is displayed.
(10)

The information processing device according to any one of (6) to (9) above, further including:
an information processing section that executes the predetermined process on the sensor data from at least one of the sensors.
(11)

The information processing device according to any one of (6) to (10) above, further including:
the sensors.
(12)

The information processing device according to any one of (2) to (11) above, in which
the communication section receives remote support information including information for executing the remote support on the mobile object, from the mobile object via the second communication line.
(13)

The information processing device according to (12) above, in which
the remote support device performs remote driving of the mobile object, and
the remote support information includes information for performing the remote driving of the mobile object.
(14)

The information processing device according to any one of (1) to (13) above, in which
the communication control section further selects a communication line through which the transmission data is transmitted, on the basis of the communication situation of each of the communication lines.
(15)

The information processing device according to any one of (1) to (14) above, in which
the characteristic of each of the communication lines includes a communication speed and reliability, and
the characteristic of the transmission data includes at least one of an amount, a type, and an importance of the data.
(16)

The information processing device according to any one of (1) to (15) above, in which
the transmission data is used by the remote support device to monitor states of surroundings of the mobile object.
(17)

The information processing device according to any one of (1) to (16) above, in which
the remote support includes one or more of remote monitoring, remote assistance, and remote driving of the mobile object.
(18)

The information processing device according to (17) above, in which
the mobile object includes a vehicle.
(19)

A method for processing information including:
by an information processing device capable of communicating, in a mobile object, with a remote support device that performs remote support for the mobile object, via a plurality of communication lines,
selecting a communication line for transmitting transmission data to the remote support device, on the basis of a characteristic of the transmission data including information to be used in the remote support device and a characteristic of each of the communication lines.
(20)

A program for causing a computer capable of communicating, in a mobile object, with a remote support device that performs remote support for the mobile object, via a plurality of communication lines to execute a process of:
selecting a communication line for transmitting transmission data to the remote support device, on the basis of a characteristic of the transmission data including information to be used in the remote support device and a characteristic of each of the communication lines.

It should be noted that the effects described in the present description are merely examples and are not limiting, and other effects may also be obtained.

### REFERENCE SIGNS LIST

1: Remote support system
11: Vehicle
12: Remote support device
13: High-speed line
14: High-reliability line
21: Sensor unit
22: Motion unit
23: Vehicle control unit
24: Communication unit
31: High-speed line communication unit
32: High-reliability line communication unit
101: Remote driving system
111: Vehicle
112: Remote driving device
113: High-speed line
114: High-reliability line
121: Sensor unit
122: Motion unit
123: Vehicle control unit
124: Communication unit
131: Camera
132: LiDAR
133: Radar
141: Communication control section
142: Video compressing section
143: Data processing section
144: State information generating section
145: Motion control section
151: High-speed line communication unit
152: High-reliability line communication unit
161: Communication unit
162: Video drawing section
163: Surrounding information drawing section
164: Display unit
165: Operation unit
166: Remote driving information generating section
171: High-speed line communication unit
172: High-reliability line communication unit

1. An information processing device comprising:
a communication unit capable of communicating, in a mobile object, with a remote support device that performs remote support for the mobile object, via a plurality of communication lines; and
a communication control section that selects a communication line that transmits transmission data to the remote support device, on a basis of a characteristic of the transmission data including information to be used in the remote support device and a characteristic of each of the communication lines.

2. The information processing device according to claim 1, wherein
the plurality of communication lines includes a first communication line, and a second communication line which has a slower communication speed and higher reliability than the first communication line.

3. The information processing device according to claim 2, wherein
the communication control section selects the first communication line for first transmission data, and selects the second communication line for second transmission data, which is data having a smaller data amount than the first transmission data or data having a higher importance than the first transmission data.

4. The information processing device according to claim 3, wherein
the communication control section selects the second communication line for the first transmission data in a case where an abnormality occurs in the first communication line.

5. The information processing device according to claim 4, further comprising:
a data processing section that reduces a data amount of the first transmission data, in a case where the first transmission data is transmitted via the second communication line.

6. The information processing device according to claim 3, wherein
the first transmission data includes sensor data from at least one of one or more sensors that acquire information regarding at least one of the mobile object and surroundings of the mobile object, or sensor information including similar data, and
the second transmission data includes a sensor processing result that is a result of performing a predetermined process on the sensor data from at least one of the sensors.

7. The information processing device according to claim 6, wherein
the sensor processing result includes information detected on a basis of the sensor data from at least one of the sensors.

8. The information processing device according to claim 7, wherein
the sensor information includes video data of the surroundings of the mobile object, and
the sensor processing result includes a detection result of a state of the surroundings of the mobile object.

9. The information processing device according to claim 8, wherein
in the remote support device, information in which the detection result of the state of the surroundings of the mobile object is superimposed on a video based on the video data is displayed.

10. The information processing device according to claim 6, further comprising:
an information processing section that executes the predetermined process on the sensor data from at least one of the sensors.

11. The information processing device according to claim 6, further comprising:
the sensors.

12. The information processing device according to claim 2, wherein
the communication section receives remote support information including information for executing the remote support on the mobile object, from the mobile object via the second communication line.

13. The information processing device according to claim 12, wherein
the remote support device performs remote driving of the mobile object, and
the remote support information includes information for performing the remote driving of the mobile object.

14. The information processing device according to claim 1, wherein
the communication control section further selects a communication line through which the transmission data is transmitted, on a basis of the communication situation of each of the communication lines.

15. The information processing device according to claim 1, wherein
the characteristic of each of the communication lines includes a communication speed and reliability, and
the characteristic of the transmission data includes at least one of an amount, a type, and an importance of the data.

16. The information processing device according to claim 1, wherein
the transmission data is used by the remote support device to monitor states of surroundings of the mobile object.

17. The information processing device according to claim 1, wherein
the remote support includes one or more of remote monitoring, remote assistance, and remote driving of the mobile object.

18. The information processing device according to claim 17, wherein
the mobile object includes a vehicle.

19. A method for processing information comprising:
by an information processing device capable of communicating, in a mobile object, with a remote support device that performs remote support for the mobile object, via a plurality of communication lines,
selecting a communication line for transmitting transmission data to the remote support device, on a basis of a characteristic of the transmission data including information to be used in the remote support device and a characteristic of each of the communication lines.

20. A program for causing a computer capable of communicating, in a mobile object, with a remote support device that performs remote support for the mobile object, via a plurality of communication lines to execute a process of:
selecting a communication line for transmitting transmission data to the remote support device, on a basis of a characteristic of the transmission data including information to be used in the remote support device and a characteristic of each of the communication lines.
